(19) United States
(12) Patent Application Publication
(10) Pub. No.: US 2006/0020819 A1
(43) Pub. Date: Jan. 26, 2006

(54) Information processing apparatus and system startup method

(75) Inventor: Hiroshi Yamazaki, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/167,559

(22) Filed: Jun. 28, 2005

(30) Foreign Application Priority Data
Jun. 29, 2004 (JP) 2004-191499

(51) Int. Cl. H04L 9/00

(52) U.S. Cl. 713/183

(57) ABSTRACT

When the apparatus power supply is turned on, a CPU executes a password input processing routine in the initialization processing routine of the BIOS, and check, using information on the checking result of the previous password input operation, whether the current password input operation has failed.

### CROSS-REFERENCE TO RELATED APPLICATIONS

This application is based upon and claims the benefit of priority from prior Japanese Patent Application No. 2004-191499, filed Jun. 29, 2004, the entire contents of which are incorporated herein by reference.

### BACKGROUND OF THE INVENTION

1. Field of the Invention

The present invention relates to an information processing apparatus which has password setting and input functions, and a system startup method which is suitably applied to an information processing apparatus such as a personal computer, which has a password input function that requires input of a password when it is used.

2. Description of the Related Art

As described in, e.g., Jpn. Pat. Appln. KOKAI Publication No. 2000-259276, a personal computer enables a function of requiring input of a password every time its power supply is turned on, thus avoiding its unauthorized use. Upon input of a password, if password input has failed a predetermined number of trials, the system power supply is turned off or the system state is locked, thereby preventing unauthorized use of the apparatus.

Conventionally, when the power supply of the personal computer is turned on again, another trial of password input is allowed. Therefore, by repeating this operation, the probability of avoiding unauthorized use of the apparatus decreases. Hence, even when each password input function is complicated, high protection against unauthorized use cannot be expected although the usability of the apparatus worsens.

The aforementioned conventional password input function is defective in terms of security. An apparatus which has higher usability and a password input function with higher reliability than that of a conventional apparatus is demanded.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below serve to explain the principles of the invention.

FIG. 1 is a block diagram showing an example of the arrangement of a personal computer according to embodiments of the present invention;

FIG. 2 shows an example of the configuration of a password setting window according to the embodiments of the present invention;

FIG. 3 is a flowchart showing an example of the processing sequence of a password input process according to a first embodiment of the present invention;

FIG. 4 is a flowchart showing an example of the processing sequence of a password input process according to a second embodiment of the present invention;

FIG. 5 is a flowchart showing an example of the processing sequence of a password input process according to a third embodiment of the present invention; and

FIG. 6 is a flowchart showing an example of the processing sequence of a password input process according to a fourth embodiment of the present invention.

### DETAILED DESCRIPTION OF THE INVENTION

Preferred embodiments of the present invention will be described hereinafter with reference to the accompanying drawings.

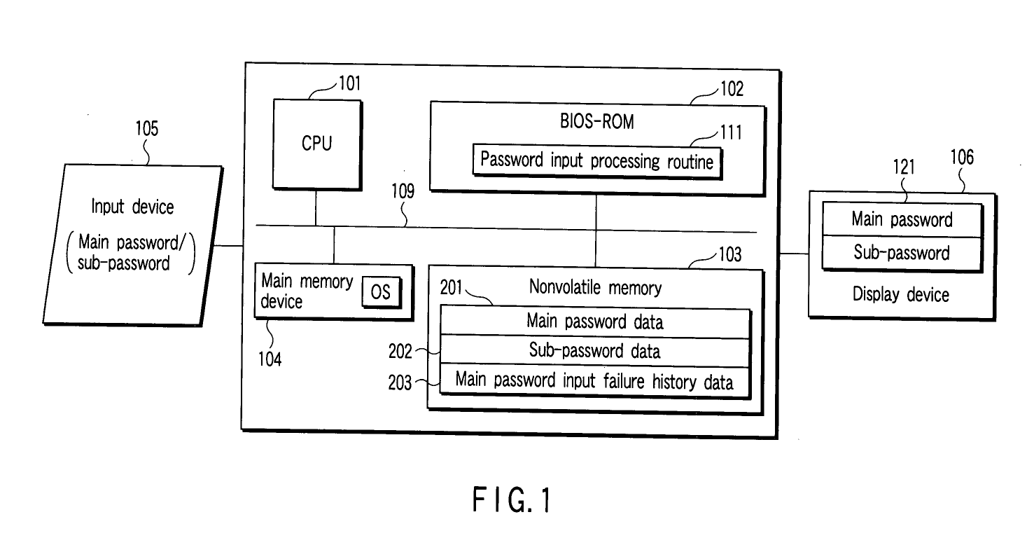

FIG. 1 shows an example of the arrangement of a personal computer according to an embodiment of the present invention. The personal computer comprises a CPU 101, BIOS-ROM 102, nonvolatile memory 103, main memory device 104, input device 105, display device 106, and the like.

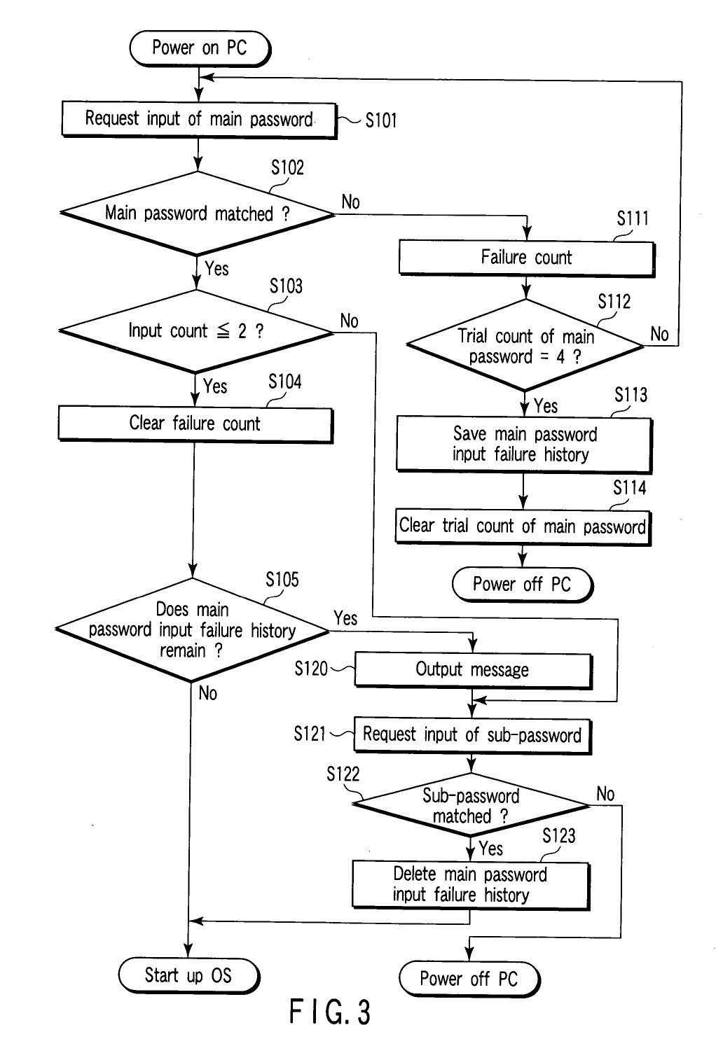

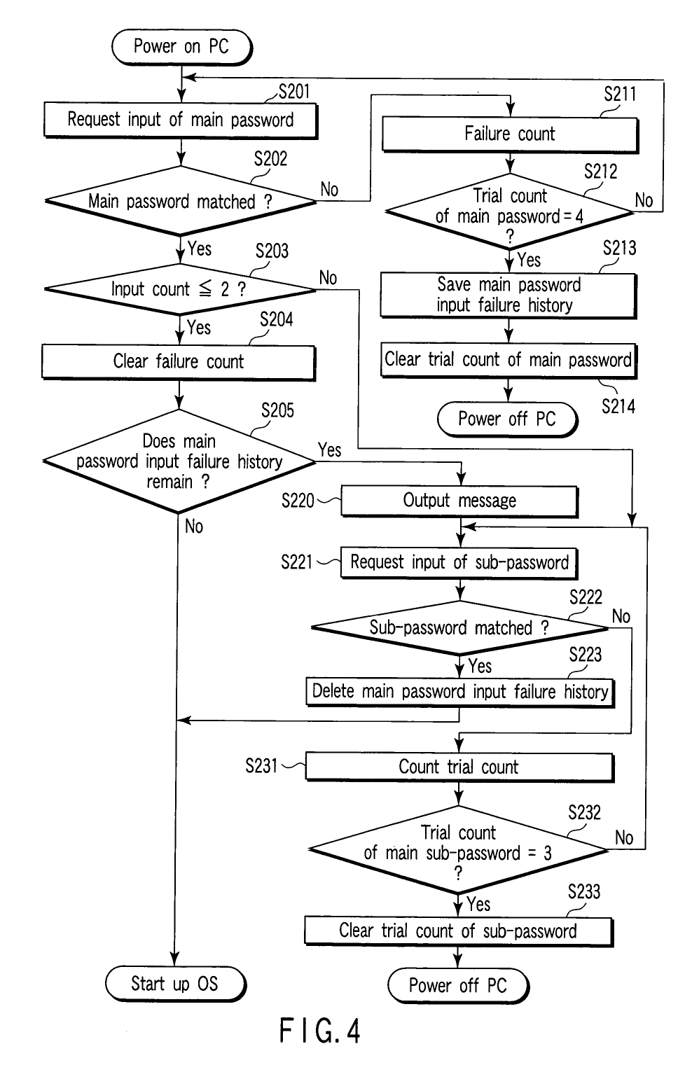

The CPU 101 controls the entire system of the personal computer, and executes an operating system (OS) and various applications/utility programs which are loaded from a hard disk drive (not shown) into the main memory device 104. The CPU 101 executes a system BIOS stored in the BIOS-ROM 102. Furthermore, in this embodiment, the CPU 101 executes a process of a password input processing routine 111 included in the system BIOS. The processing sequence of this password input processing routine 111 will be described later with reference to FIGS. 3 and 4.

The BIOS-ROM 102 stores the password input processing routine 111 which has the processing sequence shown in FIGS. 3 and 4, so as to implement a convenient password input function with higher reliability in the embodiment of the present invention. This password input processing routine 111 is executed by the CPU 101 when the apparatus power supply is turned on (power on) that requires password input.

The nonvolatile memory 103 comprises, e.g., a flash memory. Parameter blocks of the memory store and save main password data 201, sub-password data 202, main password input failure history data 203, and the like. The main password data 201 and sub-password data 202 are data which indicate passwords set by the user. The main password input failure history data 203 is information indicating whether or not input of the main password has failed, and is held until at least the next password input operation is completed. More specifically, the main password input failure history data 203 is reference information which is used in the password input processing routine 111 to confirm whether or not the password input failed in the previous main password input operation upon inputting the main password.

The input device 105 is, e.g., a keyboard unit which allows the user to set and input the main and sub-passwords. The input device 105 is operated when the authentic user sets main and sub-passwords and inputs them after settings.

The display device 106 selectively displays a password setting window or password input window, which prompts the user to set or input the main and sub-passwords upon setting or inputting them.

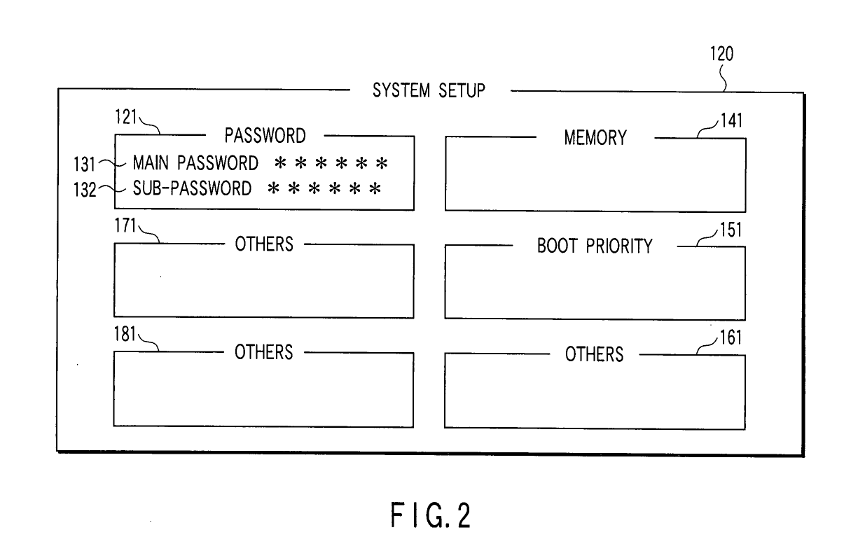

FIG. 2 shows an example of the password setting window used to set the main and sub-passwords. In this case, a password setting area 121 having a main password setting field 131 and sub-password setting field 132 is assured in a system setup window 120. The authentic user sets main and sub-passwords in the password setting area 121 on this setup window. Data of the main and sub-passwords set in the main and sub-password setting fields 131 and 132 of this password setting area 121 are set and saved as the main and sub-password data 201 and 202 in the nonvolatile memory 103, and are referred to in the process of the password input processing routine 111 under control of the CPU 101.

Note that a memory setting area 141 used to set a memory, a boot priority setting area 151 used to set boot priority, and setting areas 161, 171, and 181 used to set other parameters may be assured in this system setup window 120 in addition to the aforementioned password setting area 121. Details of these areas will be omitted.

FIG. 3 shows the processing sequence according to a first embodiment of the password input processing routine 111. FIG. 3 shows a setting example when the number of allowable trials of main password input is 3.

When the apparatus power supply is turned on (power on) in the personal computer, the CPU 101 executes an initialization processing routine of the BIOS, and the password input processing routine 111 during that routine.

In the process of this password input processing routine 111, the main password input failure history data 203 held in the nonvolatile memory 103 is referred to as previous history data used to determine if the previous main password input operation failed.

In the process of the password input processing routine 111 according to the first embodiment shown in FIG. 3, the display device 106 displays a password input window having a main password input field, and prompts the user to input a main password (step S101).

Where the user inputs a main password by operating the input device 105, the input main password is verified with the main password data 201 saved in the nonvolatile memory 103, thus checking if the input main password matches the registered main password (step S102).

If it is determined that the main password matches (YES in step S102), a trial count is checked (step S103). If the trial count is 2 or less (YES in step S103), the count value of the trial count (failure count) is cleared (step S104). It is then checked with reference to the main password input failure history data 203 saved in the nonvolatile memory 103 if main password input failed in the previous password input operation (step S105).

If no failure history remains (NO in step S105), it is determined that the user of interest is authentic, and the operating system (OS) is started up.

If a failure history remains (YES in step S105), a message indicating that main password input failed in the previous password input operation or a message indicating that unauthorized use was made is displayed on the display device 106 (step S120). Furthermore, a password input window having a sub-password input field is displayed on the display device 106 (step S121) to display a message indicating that unauthorized use was made and to prompt the user to input a sub-password.

Where a sub-password is input to the sub-password input field, the input sub-password is verified with the sub-password data 202 saved in the nonvolatile memory 103 (step S122). If the sub-password matches (YES in step S122), the main password input failure history data 203 saved in the nonvolatile memory 103 is cleared (step S123), and the operating system (OS) is started up.

If the sub-password does not match in verification (NO in step S122), the system power supply of the personal computer is turned off.

If the main password does not match in verification (NO in step S102), the number of trials is counted (failure count) (step S111). It is checked whether the trial count of main password input has reached 4 (step S112).

If the trial count has not reached 4 (NO in step S112), the display device 106 displays the password input window having the main password input field again to prompt the user to input a main password (step 101).

If the trial count has reached 4 (YES in step S112), the main password input failure history data 203 indicating that the main password input operation failed is saved in the nonvolatile memory 103 (step S113). The trial count of main password input is cleared (step S114), and the system power supply of the personal computer is turned off.

According to the password input process of the first embodiment, the password operation in a normal use pattern of a single user can be minimized. In addition, even when an inexperienced user has failed password input where the apparatus is used by a plurality of users, only an authentic user can use the apparatus. Furthermore, the authentic user can be notified of unauthorized use.

FIG. 4 shows the processing sequence according to a second embodiment of the password input processing routine 111. FIG. 4 shows a setting example when the allowable trial count of main password input is 3, and the allowable trial count of sub-password input is 2.

In the process of the password input processing routine 111 according to the second embodiment shown in FIG. 4, the display device 106 displays a password input window having a main password input field, and prompts the user to input a main password (step S201).

Where the user inputs a main password by operating the input device 105, the input main password is verified with the main password data 201 saved in the nonvolatile memory 103, thus checking whether the input main password matches the registered main password (step S202).

If it is determined that the main password matches (YES in step S202), the trial count is checked (step S203). If the trial count is 2 or less (YES in step S203), the count value of the trial count (failure count) is cleared (step S204). It is then checked with reference to the main password input failure history data 203 saved in the nonvolatile memory 103 whether main password input failed in the previous password input operation (step S205).

If no failure history remains (NO in step S205), it is determined that the user of interest is authentic, and the operating system (OS) is started up.

If a failure history remains (YES in step S205), a message indicating that main password input failed in the previous password input operation or a message indicating that unauthorized use was made is displayed on the display device 106 (step S220). Furthermore, a password input window having a sub-password input field is displayed on the display device 106 (step S221) to display a message indicating that unauthorized use was made and to prompt the user to input a sub-password.

Where a sub-password is input to the sub-password input field, the input sub-password is verified with the sub-password data 202 saved in the nonvolatile memory 103 (step S222). If the sub-password matches (YES in step S222), the main password input failure history data 203 saved in the nonvolatile memory 103 is cleared (step S223), and the operating system (OS) is started up.

If the main password does not match in verification of them (NO in step S202), the number of trials is counted (failure count) (step S211). It is checked whether the trial count of main password input has reached 4 (step S212).

If the trial count has not reached 4 (NO in step S212), the display device 106 displays the password input window having the main password input field again to prompt the user to input a main password (step S201).

If the trial count has reached 4 (YES in step S212), the main password input failure data 203 indicating that the main password input operation failed is saved in the nonvolatile memory 103 (step S213). The trial count of main password input is cleared (step S214), and the system power supply of the personal computer is turned off.

If the sub-password does not match in verification (NO in step S222), the trial count of sub-password input is counted (step S231) to check if the trial count of sub-password input has reached 3 (step S232).

If the trial count has not reached 3 (NO in step S232), the display device 106 displays the password input window having the sub-password input field again to prompt the user to input a sub-password (step S221).

If the trial count has reached 3 (YES in step S232), the trial count of sub-password input is cleared (step S233), and the system power supply of the personal computer is turned off.

According to the password input process of the second embodiment as well, the password operation in a normal use pattern of a single user can be minimized. In addition, even when an inexperienced user has failed password input where the apparatus is used by a plurality of users, only an authentic user can use the apparatus. Furthermore, the authentic user can be notified of unauthorized use.

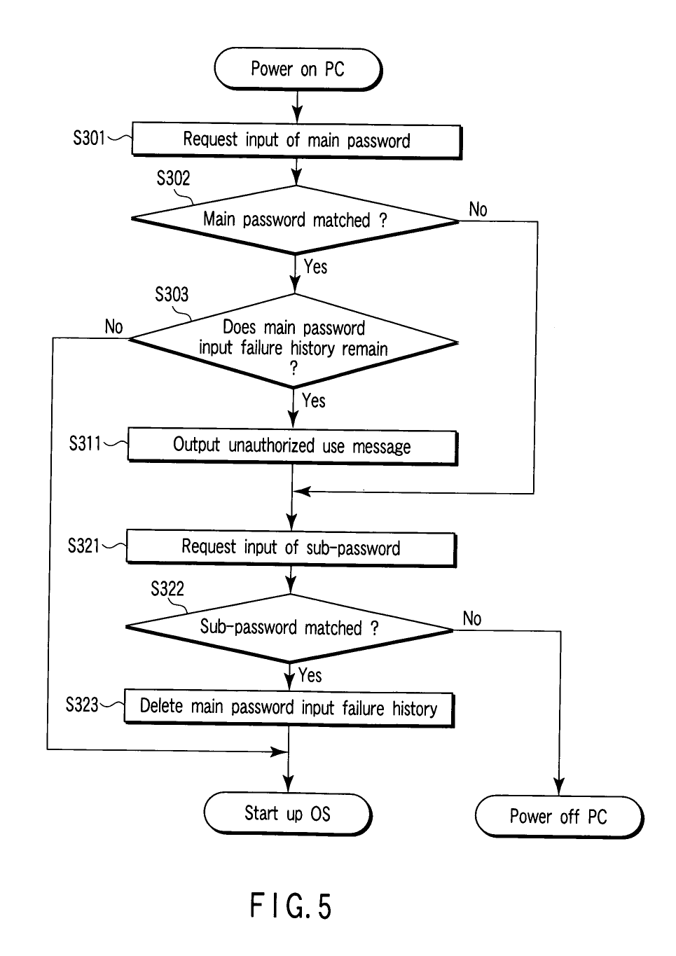

FIG. 5 shows the processing sequence according to a third embodiment of the password input processing routine 111. FIG. 5 shows a setting example when the allowable trial count of main password input is 1. Since the process of the third embodiment is substantially the same as that of the first embodiment except that the allowable trial count of main password input is 1, a detailed description of the processing sequence will be omitted.

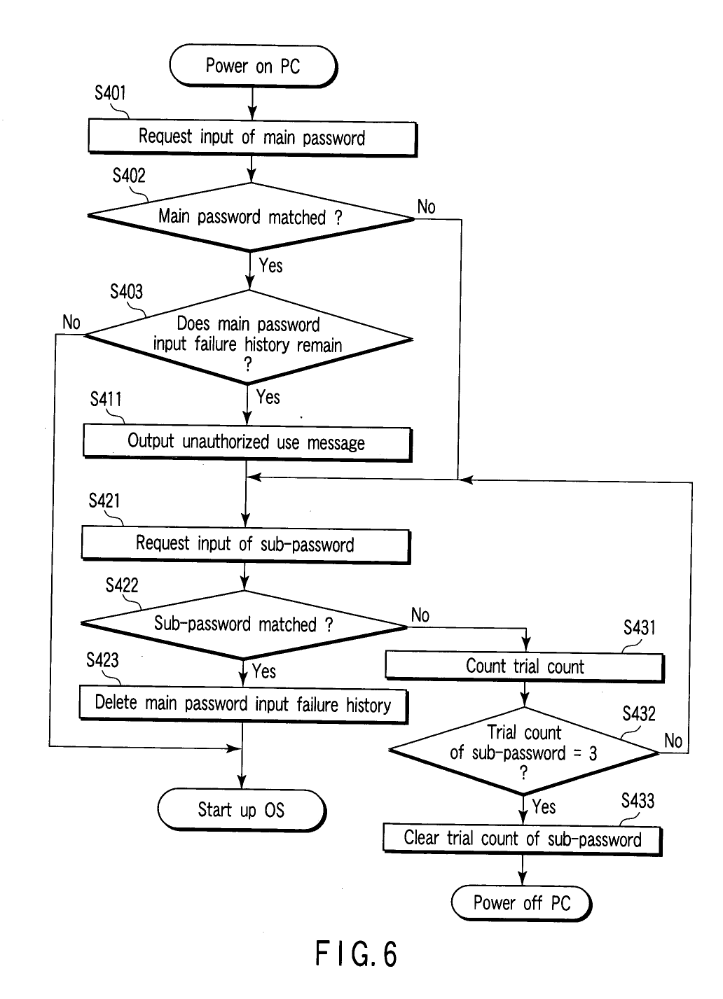

FIG. 6 shows the processing sequence according to a fourth embodiment of the password input processing routine 111. FIG. 6 shows a setting example when the allowable trial count of main password input is 1, and the allowable trial count of sub-password input is 2. Since the process of the fourth embodiment is substantially the same as that of the second embodiment except that the allowable trial count of main password input is 1, a detailed description of the processing sequence will be omitted.

According to the password input process of the third and fourth embodiments as well, the password operation in a normal pattern of use by a single user can be minimized. In addition, even when an inexperienced user has failed password input where the apparatus is used by a plurality of users, only an authentic user can use the apparatus. Furthermore, the authentic user can be notified of unauthorized use.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising a password processing unit that sets, inputs, and verifies a password, comprising:
a password checking unit which checks whether an input operation of the password input to the password processing unit has failed; and
a history save unit which saves information of a checking result of the password checking unit until at least the next password input operation ends,
wherein the password checking unit checks using the information of the checking result of a previous password input operation saved in the history save unit in the input operation of the password to the password processing unit whether the current input operation of the password has failed.

2. An apparatus according to claim 1, wherein the password checking unit comprises a first trial input unit which permits password input up to a predetermined trial count in the input operation of the password.

3. An apparatus according to claim 2, further comprising:
a trial count holding unit which counts and holds a trial count of the password input to the first trial input unit;
a trial count checking unit which checks whether the trial count held by the trial count holding unit has reached a predetermined count;
a sub-password request unit which requests input of a sub-password when the trial count checking unit determines that the trial count has reached the predetermined count;
a sub-password checking unit for checking whether the input operation of the sub-password requested by the sub-password request unit has failed; and
a processing operation termination unit which terminates processing by the apparatus when the sub-password checking unit determines that the input operation has failed.

4. An apparatus according to claim 3, wherein the sub-password checking unit comprises a second trial input unit which permits sub-password input up to a predetermined trial count in the input operation of the sub-password.

5. An apparatus according to claim 4, wherein the password processing unit simultaneously sets the password and the sub-password.

6. An apparatus according to claim 1, further comprising a message output unit which refers to information saved in the history save unit when the password checking unit determines that the input operation of the password input to the password processing unit has succeeded, and outputs a message that prompts a user to confirm unauthorized use or a message indicating that unauthorized use was made when the information is information of the checking result indicating that the previous password input operation failed.

7. An apparatus according to claim 6, wherein the history save unit saves all passwords input in the password input operations which have failed, and the message output unit outputs the message that prompts the user to confirm unauthorized use or the message indicating that unauthorized use was made in consideration of all the passwords saved in the history save unit.

8. A system startup method for an information processing apparatus which comprises a password processing unit that sets, inputs, and verifies a password, comprising:
checking whether an input operation of the password input to the password processing unit has failed; and
saving, in a history save unit, information of a checking result until at least the next password input operation ends,
wherein the checking step comprises a step of checking using the information of the checking result of a previous password input operation saved in the history save unit in the input operation of the password to the password processing unit whether the current input operation of the password has failed, and determining based on the checking result whether to start up a system.
